(19) United States
(12) Patent Application Publication
(10) Pub. No.: US 2022/0164573 A1
(43) Pub. Date: May 26, 2022

(54) BUSINESS CARD MANAGEMENT DEVICE AND NON-TRANSITORY COMPUTER READABLE MEDIUM STORING BUSINESS CARD MANAGEMENT PROGRAM

(71) Applicant: FUJIFILM Business Innovation Corp., Tokyo (JP)

(72) Inventors: Masafumi CHIKYU, Kanagawa (JP); Takashi HASHIZUME, Kanagawa (JP); Xinyu PENG, Kanagawa (JP); Shuhei KAWASHIMA, Kanagawa (JP); Yoshihiro KUDO, Kanagawa (JP)

(73) Assignee: FUJIFILM Business Innovation Corp., Tokyo (JP)

(21) Appl. No.: 17/306,175

(22) Filed: May 3, 2021

(30) Foreign Application Priority Data
Nov. 25, 2020 (JP) 2020-195514

(51) Int. Cl. G06K 9/00; G06K 9/20

(52) U.S. Cl. CPC G06K 9/00483; G06K 2209/01; G06K 9/2054; G06K 9/00463

(57) ABSTRACT

A business card management device includes a processor configured to: associate, upon a determination that first business card data obtained by performing character recognition on an image of a business card matches second business card data pre-stored, the second business card data pre-stored with the image of the business card; and receive, upon a determination that the first business card data does not match any business card data pre-stored, an input of information to the first business card data.

### CROSS-REFERENCE TO RELATED APPLICATIONS

This application is based on and claims priority under 35 USC 119 from Japanese Patent Application No. 2020-195514 filed on Nov. 25, 2020.

### BACKGROUND

### (i) Technical Field

The present disclosure relates to a business card management device and a non-transitory computer readable medium storing a business card management program.

### (ii) Related Art

Japanese patent No. 6581684 discloses a business card management system in which multiple users are connected to a server via respective terminals, and a business card exchanger among the users registers business card information of a business card exchange partner, and refers to the business card information registered by the himself/herself and other business card exchangers. The business card management system includes: a retriever that retrieves business card information from a database; a display controller that displays a predetermined screen on a corresponding one of the terminals; an input that receives data from the terminal; and a register that registers the data received by the input in the database. The display controller displays a partial input screen that receives an input of partial information of the business card information to be newly registered. The partial information also includes information other than name, and the retriever retrieves from the database business card information with the partial information duplicated. The display controller displays the duplicated business card information as a duplicate list. When one piece of business card information is selected from the duplicate list in the terminal, even when the business card information of a non-identical person is selected, the display controller displays a detail input screen which receives an input of all business card information, and sets the value of the selected business card information as the initial value for each input frame of an input screen.

### SUMMARY

A business card management system to manage business card is known. In the business card management system, business card data indicating the images and content of business cards is registered. The business card data is registered in the business card management system, for instance, by manual input of an operator.

The business card management system may be shared by multiple users. In this case, for instance, the same business cards received from the same person may be registered redundantly by multiple users in the business card management system. If the business card data for all redundantly registered business cards are manually input, the labor charge for the manual input is also incurred.

Aspects of non-limiting embodiments of the present disclosure relate to a business card management device and a non-transitory computer readable medium storing a business card management program that are capable of reducing manual input operation, as compared with when the business card data for all business cards to be registered in the business card management system are manually input.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a business card management device including a processor configured to: associate, upon a determination that first business card data obtained by performing character recognition on an image of a business card matches second business card data pre-stored, the second business card data pre-stored with the image of the business card; and receive, upon a determination that the first business card data does not match any business card data pre-stored, an input of information to the first business card data.

### BRIEF DESCRIPTION OF THE DRAWINGS

Exemplary embodiments of the present disclosure will be described in detail based on the following figures, wherein:

FIG. 1 is an illustration depicting a schematic configuration example of a business card management device;

FIG. 2 is a block diagram illustrating a hardware configuration of the business card management device;

FIG. 3 is a flowchart illustrating the flow of business card management processing performed by the business card management device;

FIG. 4 is a table illustrating an example of a criterion for each of items as to whether first business card data matches second business card data;

FIG. 5A is second business card data, and FIGS. 5B and 5C are first business card data illustrating examples as to whether the business card data of FIGS. 5B and 5C matches (is considered to be the same as) the business card data of FIG. 5A;

FIG. 6A is second business card data, and FIGS. 6B and 6C are first business card data illustrating examples as to whether the business card data of FIGS. 6B and 6C matches (is considered to be the same as) the business card data of FIG. 6A; and

FIG. 7A is second business card data, and FIGS. 7B and 7C are first business card data illustrating examples as to whether the business card data of FIGS. 7B and 7C matches (is considered to be the same as) the business card data of FIG. 7A.

### DETAILED DESCRIPTION

Hereinafter, an exemplary embodiment will be described with reference to the drawings. Note that the same symbols are assigned to the same components and the same processing in the all drawings, and a redundant description is omitted.

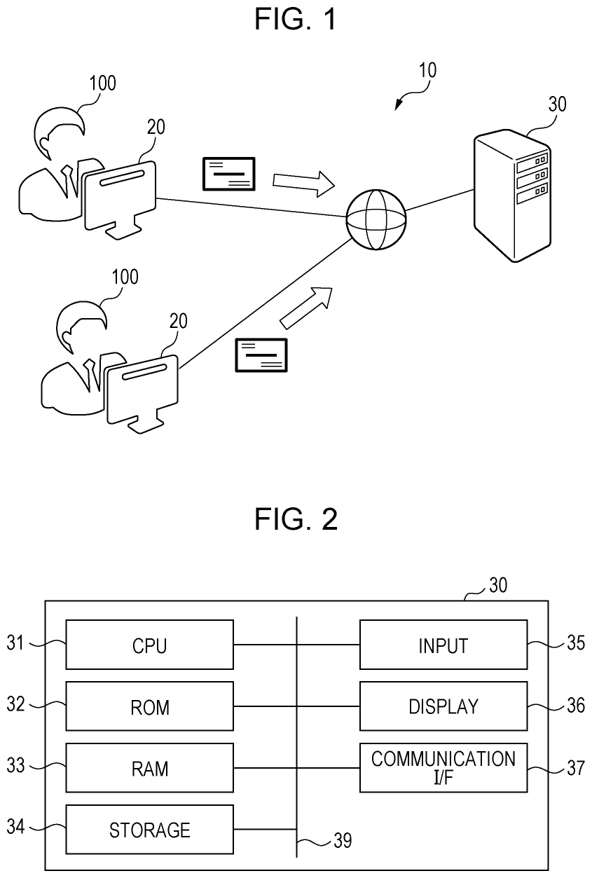

FIG. 1 is an illustration depicting a schematic configuration of a business card management system according to the exemplary embodiment.

FIG. 1 is an illustration depicting a schematic configuration of a business card management system 10 having a business card management device 30 according to the exemplary embodiment.

As illustrated in FIG. 1, the business card management system 10 is configurated by connecting a user terminal 20 used by a user 100 as a user and a business card management device 30 as a server device to a communication unit such as a network. Note that, as described below, various wireless or wired networks, such as Internet, Ethernet (registered trademark) or WiFi (registered trademark) may be utilized as a communication unit. Although FIG. 1 illustrates an example in which two users 100, two user terminals 20, and one business card management device 30 are provided, the number of users, the number of user terminals and the number of business card management devices are not limited to these.

The business card management system 10 manages business cards in the business card management device 30, the business cards being input to the user terminals 20 by the users 100. Note that, in FIG. 1, the business card management device 30 is illustrated as another device different from the user terminals 20. However, the business card management device 30 can be implemented in any computer, and may be implemented in one of the user terminals 20.

FIG. 2 is a block diagram illustrating a hardware configuration of the business card management device 30.

As illustrated in FIG. 2, the business card management device 30 has the function as a computer, and includes a central processing unit (CPU) 31 which is an example of a processor, a read only memory (ROM) 32, a random access memory (RAM) 33, a storage 34, an input 35 as a user interface, a display 36 which is a liquid crystal display device, and a communication interface (I/F) 37. The components of the business card management device 30 are connected to each other via a bus 39 to allow communication therebetween.

The CPU 31, which is an example of a processor, is central arithmetic processing unit, and executes various programs and controls each component. Specifically, the CPU 31 reads a program from the ROM 32 or the storage 34, and executes the program using the RAM 33 as a work area. The CPU 31 controls the components of the business card management device 30 and performs various types of arithmetic processing in accordance with the programs stored in the ROM 32 or the storage 34.

The ROM 32 stores various programs and various data. The RAM 33 serves as a work area, and temporarily stores programs or data. The storage 34 is comprised of a storage device, such as a hard disk drive (HDD) or a solid state drive (SSD), and stores various programs including the operating system, and various data.

The input 35 as a user interface is the interface when a server administrator uses the business card management device 30, and is, for instance, the input 35, such as a button, or a touch panel. The display 36 may have a display screen, such as a liquid crystal display.

The communication interface 37 is an interface to communicate with the user terminals 20, such as a PC. A wired or wireless communication is used as the communication method of the communication interface 37. For instance, Ethernet (registered trademark), FDDI, or Wi-Fi (registered trademark) is used as a communication standard of the communication interface 37.

When executing the above-mentioned programs, the business card management device 30 implements various functions using the hardware resources mentioned above.

In the exemplary embodiment, a business card management program causing a computer to function as the above-described business card management device 30 is stored in the RAM 33 or the storage 34.

The CPU 31 then can read the above-mentioned business card management program from the ROM 32 or the storage 34, and can execute the program using the RAM 33 as a work area.

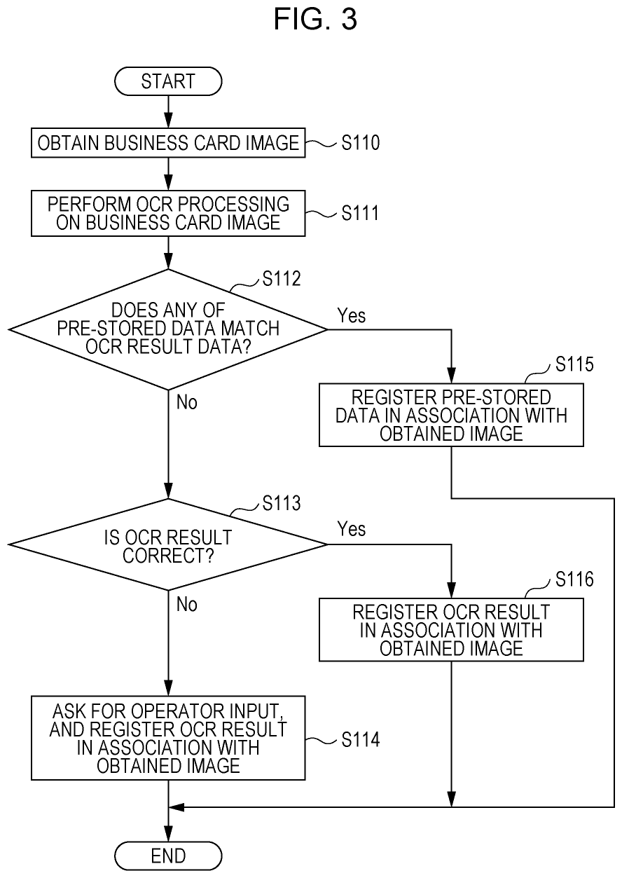

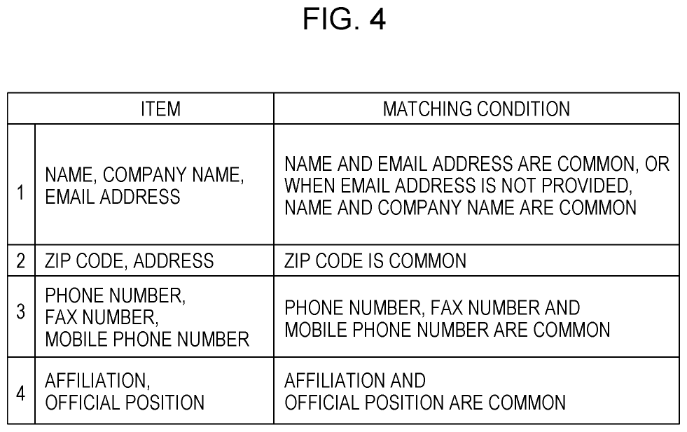

Next, the operation of the business card management device 30 will be described. FIG. 3 is a flowchart illustrating the flow of business card management processing performed by the business card management device. FIG. 4 is a table illustrating an example of a criterion for each of items as to whether first business card data matches second business card data.

In step S110, the CPU 31 obtains a business card image from a user terminal 20. A business card image is obtained, for instance, by a user scanning a business card by a scanner connected to the user terminal 20.

In step S111, the CPU 31 performs so-called optical character recognition processing (so-called OCR processing) on the obtained business card image mentioned above by software which converts image information of the characters written on the business card into code information of the characters. Hereinafter, information in which code information of characters is associated with a business card image by OCR processing is referred to as first business card data.

In step S112, the CPU 31 determines whether the first business card data matches any business card data (hereinafter, referred to as second business card data) stored in the past.

In the exemplary embodiment, the CPU 31 determines whether the first business card data matches the second business card data based on whether a “predetermined condition” is met. When the “predetermined condition” is met, matching is made, otherwise, matching is not made. The “predetermined condition” will be described in detail below.

When the CPU 31 determines that the first business card data does not match any second business card data stored (No in step S112), the flow proceeds to step S113, and when the CPU 31 determines that the first business card data matches stored business card data (Yes in step S112), the flow proceeds to step S115.

In step S113, the CPU 31 determines whether the result of the OCR processing, that is, the result of optical character recognition processing is correct. Hereinafter, the determination is referred to as the correct or incorrect determination processing.

Note that in the correct or incorrect determination processing for the content of the first business card data, the CPU 31 determines whether the content of the first business card data is correct based on whether the likelihood of each of corresponding characters included in the first business card data meets a “predetermined criterion”. The “predetermined criterion” for determining the likelihood of each of corresponding characters included in the first business card data in the correct or incorrect determination processing will be described below.

When determining that the result of the OCR processing is incorrect (No in step S113), the flow proceeds to step S114, and when determining that the result of the OCR processing is correct (Yes in step S113), the flow proceeds to step S116.

In step S114, the CPU 31 asks an operator to provide a prepared input, and registers the result of the input in association with the business card image to be registered this time. Then, the processing is completed.

In other words, in the exemplary embodiment, when the first business card data obtained by performing character recognition on the image of the business card does not match any second business card data pre-stored, and the content of the first business card data is incorrect, the CPU 31 receives an input of information to the first business card data by an operator, and stores the information in the received input in association with the image of the business card.

Note that, in the exemplary embodiment, when a character or a character string is corrected by input of an operator, the character or the character string before the correction and the character or the character string after the correction are stored in association with each other as past history data. The history data are utilized as basic data to calculate the later-described likelihood of a character or a character string.

The description is returned to when the flow proceeds to step S115 after the CPU 31 determines in step S112 that the first business card data to be registered this time matches the second business card data stored (Yes in step S112).

In step S115, the CPU 31 registers the stored second business card data in association with the business card image to be registered this time. Then, the processing is completed.

In other words, in the exemplary embodiment, when the first business card data obtained by performing character recognition on the image of the business card matches the second business card data pre-stored, the CPU 31 associates the second business card data pre-stored with the image of the business card (see step S115), otherwise, the CPU 31 receives an input of information to the first business card data (see step S114 described below).

According to the exemplary embodiment, as compared with when business card data is manually input for all business cards to be registered in the business card management device 30, a user or an operator does not have to manually input business card data when the business card data matches pre-stored business card data.

The description is returned to when the flow proceeds to step S116 after the CPU 31 determines in step S113 that the result of OCR processing is correct (Yes in step S113).

In step S116, the CPU 31 registers the first business card data, which is the result of OCR processing in step S111, in association with the business card image to be registered this time. Then, the processing is completed.

In other words, in the exemplary embodiment, when the first business card data obtained by performing character recognition on the image of the business card does not match any second business card data pre-stored, and the content of the first business card data is correct, the CPU 31 stores the first business card data in association with the image of the business card.

Also, according to the exemplary embodiment, when the content of the first business card data obtained by performing character recognition is correct, it is unnecessary to input correct information to the first business card data. Thus, a user neither input information nor uses a paid service, such as asking another person serving as an operator to input information. In the case where the first business card data does not match any second business card data, as compared with when it is not determined whether the first business card data is correct, when the first business card data is determined to be correct, the information input is saved, and further reduction in the cost can be achieved.

Next, as described above, the CPU 31 determines whether the first business card data matches the second business card data based on whether a “predetermined condition” is met. An example of the content of the “predetermined condition” will be described below with reference to FIG. 4.

In the exemplary embodiment, an attribute is pre-assigned to all corresponding characters or character strings included in the first business card data and the second business card data. For instance, an attribute of “name” is assigned to the characters of “Taro Fuji” written on a business card. For instance, when association of the image of a business card with business card data is established, an attribute is automatically or manually assigned. Assignment of an attribute is a well-known technique; thus a description thereof is omitted.

As illustrated on the left column, ITEM of FIG. 4, the table indicating predetermined conditions lists four items (1) to (4). In the items (1) to (4), attributes of characters or character strings are written, which are included in the first business card data and the second business card data.

Specifically, attributes of “name, company name, email address” are written in the item (1) of FIG. 4. For the attributes, “name and email address are common, or when an email address is not written, name and company name are common” is set as the above-mentioned “predetermined condition” in the right column, “matching condition” of FIG. 4.

The setting means that for the attributes of “name, company name, email address” shown in item (1), provided that an email address is written, when name and email address are common between the first business card data and the second business card data, the “predetermined condition” (matching condition) for the attributes of item (1) is met.

The setting also means that, for the attributes, provided that an email address is not written, when name and company name are common between the first business card data and the second business card data, the “predetermined condition” (matching condition) for the attributes of item (1) is met.

Similarly, attributes of “zip code, address” are written in item (2) of FIG. 4. For the attributes, “zip code is common” is set as the above-mentioned “predetermined condition” in the right column, “matching condition” of FIG. 4.

The setting means that for the attributes of “zip code, address” shown in item (2), even if the street number of address is different between the first business card data and the second business card data, when zip code is common, the “predetermined condition” (matching condition) for the attributes of item (2) is met.

Note that, in the exemplary embodiment, as described above, the setting is made so that even if the street number of address is different between the first and second business card data, when zip code is common, the matching condition is met. However, the disclosure is not limited to this particularly. For instance, a matching condition may be met when instead of zip code, prefectural and city government or municipality in address is common.

Also, as mentioned above, when zip code is common, the matching condition is met even if change of the street number of address, change of building name, change of floor in building, or change of town name is made.

Similarly, attributes of “phone number, FAX number, mobile phone number” are written in item (3) of FIG. 4. For the attributes, “phone number, FAX number, and mobile phone number are common” is set as the above-mentioned “predetermined condition” in the right column, “matching condition” of FIG. 4.

The setting means that for the attributes of “phone number, FAX number, mobile phone number” shown in item (3), when phone number, FAX number, and mobile phone number are common between the first and second business card data, the “predetermined condition” (matching condition) for the attributes of item (3) is met.

Note that provided that a FAX number is not written, the “predetermined condition” (matching condition) for the attributes of item (3) may be met when phone number and mobile phone number are common.

Similarly, attributes of “affiliation, official position” are written in item (4) of FIG. 4. For the attributes, “affiliation and official position are common” is set as the above-mentioned “predetermined condition” in the right column, “matching condition” of FIG. 4.

The setting means that for the attributes of “affiliation, official position” shown in item (4), when both affiliation and official position are common between the first business card data and second business card data, the “predetermined condition” (matching condition) for the attributes of item (4) is met.

In the exemplary embodiment, when the data of business cards are compared and found to be different only due to change of design in use (for instance, change of logo, change of color, and change of layout) on the surface of the business cards, and/or addition, deletion of various marks, the business cards are considered to be the same. Specifically, for instance, when business cards are different only due to addition, deletion of event sponsor mark (such as Olympics), seasonal greeting (Happy New Year), or an authorized mark (such as ISO, MS), the business cards are considered to be the same.

In the exemplary embodiment, as described above, an attribute is assigned to all corresponding characters or character strings included in the first business card data and the second business card data.

The first business card data is considered to match the second business card data when corresponding characters or character strings with a predetermined attribute assigned meet the above-mentioned “predetermined condition”, the predetermined attribute being common between the first business card data and the second business card data.

According to the exemplary embodiment, a condition to determine whether the content of the first business card data matches the content of the second business card data can be clarified by setting the above-mentioned “predetermined condition”.

Note that, in the exemplary embodiment, as illustrated in items (1) to (4) of FIG. 4, the above-mentioned multiple predetermined conditions are defined for multiple attributes, respectively. The first business card data is considered to match the second business card data when all matching conditions for the items (1) to (4) of FIG. 4 are met. However, when one or a combination of the items (1) to (4) is met, the first business card data may be determined to match the second business card data.

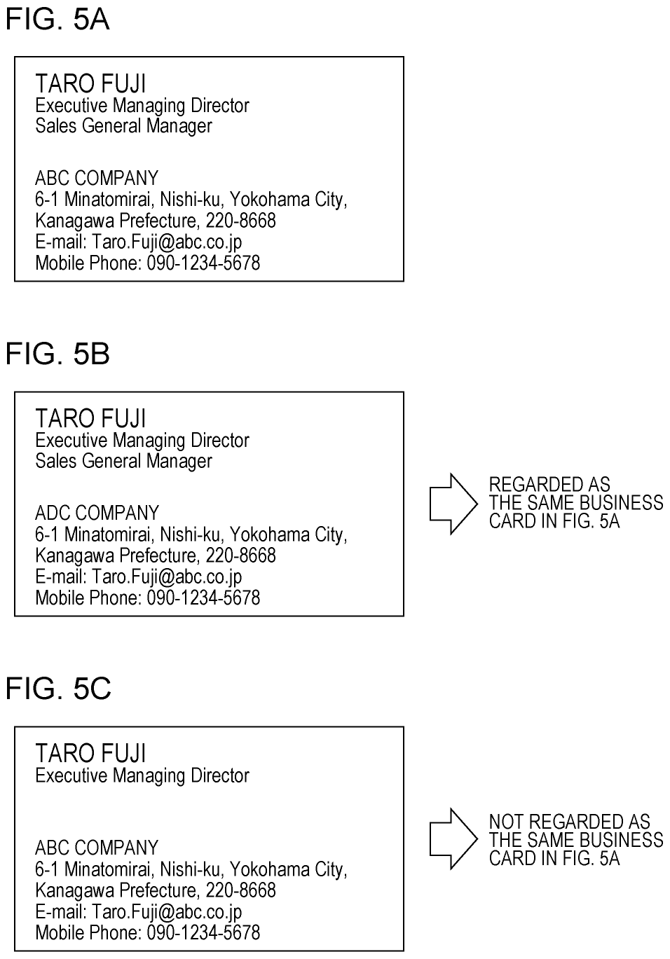

Next, a specific example as to whether the first business card data matches (is considered to be the same as) the second business card data will be described with reference to FIG. 5A to FIG. 7C.

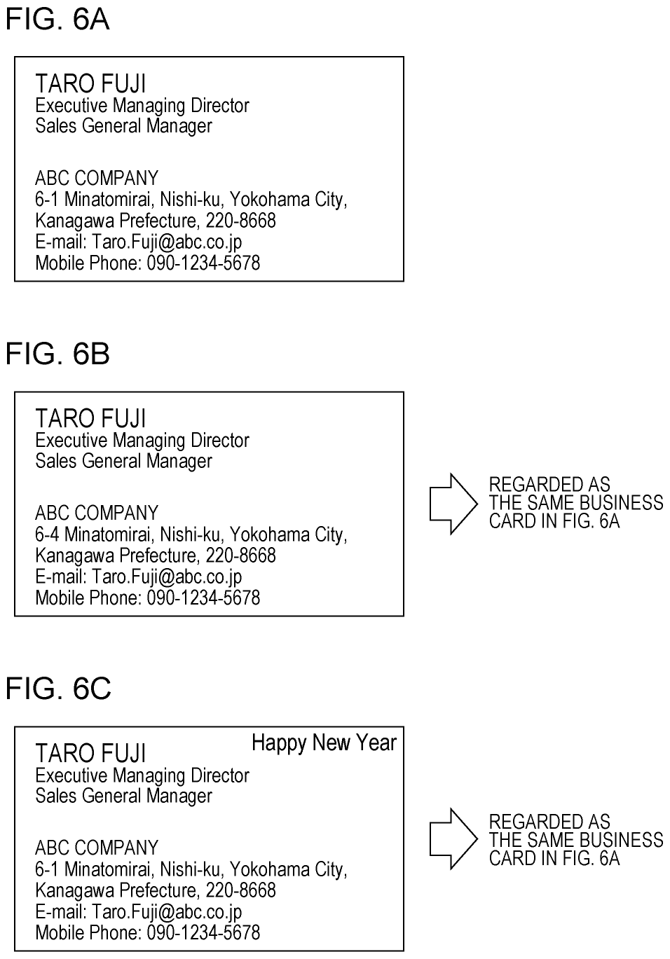

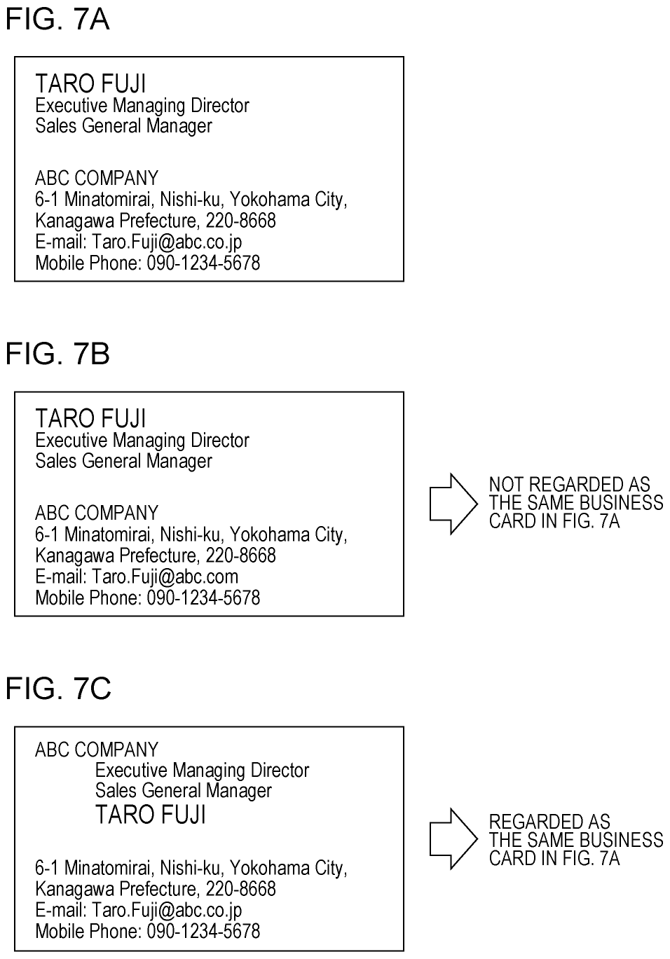

In FIGS. 5A to 5C, FIG. 5A is the second business card data, and FIGS. 5B and 5C are the first business card data illustrating examples as to whether the business card data of each of FIGS. 5B and 5C matches (is considered to be the same as) the business card data of FIG. 5A. In FIGS. 6A to 6C, FIG. 6A is the second business card data, and FIGS. 6B and 6C are the first business card data illustrating examples as to whether the business card data of each of FIGS. 6B and 6C matches (is considered to be the same as) the business card data of FIG. 6A. In FIGS. 7A to 7C, FIG. 7A is the second business card data, and FIGS. 7B and 7C are the first business card data illustrating examples as to whether the business card data of each of FIGS. 7B and 7C matches (is considered to be the same as) the business card data of FIG. 7A.

As illustrated in FIGS. 5A and 5B, although the company name is different between the business card data of FIG. 5B and the business card data of FIG. 5A, the name, and email address are common, thus the matching condition for item (1) of FIG. 4 is met, and other matching conditions are also met. Therefore, the business card data of FIG. 5B matches the business card data of FIG. 5A, and both are considered to be the same business card.

As illustrated in FIGS. 5A and 5C, “Executive Managing Director” as the affiliation, official position has not changed, but “Sales General Manager” as the official position is not written, thus the matching condition for item (4) of FIG. 4 is not met, the business card data of FIG. 5C does not match the business card data of FIG. 5A, and both are not considered to be the same business card.

As illustrated in FIGS. 6A and 6B, although the street number of address is different between the business card data of FIG. 6B and the business card data of FIG. 6A, the zip code is common, thus the matching condition for item (1) of FIG. 4 is met, and other matching conditions are also met. Therefore, the business card data of FIG. 6B matches the business card data of FIG. 6A, and both are considered to be the same business card.

As illustrated in FIGS. 6A and 6C, the business card data of FIG. 6C is obtained by adding “Happy New Year” to the business card data of FIG. 6A as a greeting for new year, and there is no difference between both contents, and the matching conditions for all items of FIG. 4 are met. Therefore, the business card data of FIG. 6C matches the business card data of FIG. 6A, and both are considered to be the same business card.

As illustrated in FIGS. 7A and 7B, the email address is different between the business card data of FIG. 7B and the business card data of FIG. 7A, thus the matching condition for item (4) of FIG. 4 is not met. Therefore, the business card data of FIG. 5C does not match the business card data of FIG. 5A, and both are not considered to be the same business card.

As illustrated in FIGS. 7A and 7C, although the overall design is different between the business card data of FIG. 7C and the business card data of FIG. 7A, the matching conditions for all items of FIG. 4 are met. Therefore, the business card data of FIG. 7C matches the business card data of FIG. 7A, and both are considered to be the same business card.

In the exemplary embodiment, in step S113 described above, the CPU 31 performs correct or incorrect determination processing on the content of recognized characters in the first business card data read by OCR processing, and determines the correctness of the first business card based on whether the likelihood of each of corresponding characters included in the first business card data meets a “predetermined criterion”. The “predetermined criterion” will be described below, which is for determining the likelihood of each of corresponding characters included in the first business card data in the correct or incorrect determination processing.

In the exemplary embodiment, when the result of recognized characters or character strings by OCR processing is incorrect, as described above, the characters or character strings are finally corrected to proper ones by operator input based on human decision, and are registered.

In the business card management device 30 according to the exemplary embodiment, the above-described processing is repeated many times, and as time elapses, past modification history is stored as historical data. Among the characters or character strings obtained by character recognition, proper characters or character strings corrected by input of an operator, and characters or character strings before corrected by input of an operator are designed to be stored as historical data with the corrected proper characters or character strings and the characters or character strings before correction associated with each other, and are stored as historical data before and after correction.

The business card management device 30 according to the exemplary embodiment is programmed so that for every recognized characters or character strings before corrected by input of an operator, percentage X (%) with which correction by input of an operator was not made in the past, that is, data of likelihood is stored.

Specifically, for instance, when a character string “ABCD” was recognized 10 times by OCR processing in the past, and was finally corrected by input of an operator all 10 times according to the past historical data, the likelihood X for the character string “ABCD” is 0%. When correction was made eight times, the likelihood X is 20%, when correction was made five times, the likelihood X is 50%, and when correction was made twice, the likelihood X is 80%.

In the exemplary embodiment, in step S113 described above, the CPU 31 performs the correct or incorrect determination processing on the content of the first business card data, and determines the correctness based on whether the likelihood X % of each of corresponding characters or character strings included in the first business card data meets a “predetermined criterion”.

According to the exemplary embodiment, each “predetermined criterion” is formed based on the above-mentioned historical data before and after correction, thus determination of the correctness of the content of the first business card data can be mechanically processed not based on human decision, but based on whether a “predetermined criterion” is met. Thus, the stability and reliability of determination of the correctness can be ensured, and effort for the determination processing can be reduced.

A specific numerical value (specifically, for instance, a numerical value such as 20% or 50%) of the “predetermined criterion” is pre-set in a program. However, the “predetermined criterion” may be freely set by a user.

In step S113, when the “likelihood X %” calculated based on the above-mentioned past history for all corresponding characters or character strings included in the first business card data is less than or equal to the “predetermined criterion”, the “predetermined criterion” is not met, and the result of character recognition is determined to be incorrect (recognition error) (No in S113), and the flow proceeds to step S114. Otherwise, the result of character recognition is determined to be correct (Yes in S113), and the flow proceeds to step S116.

The degree of “likelihood” calculated based on the above-mentioned past history for characters or character strings recognized by OCR processing performed on the first business card data is designed to be recognizable by an operator in the following manner. Depending on a predetermined numerical value range including the numerical value X of the likelihood, a rectangular frame around the characters or character strings is displayed, and the color of the rectangular frame varies according to the corresponding numerical value range. Thus, an operator who understands the degree of “likelihood” of the characters or character strings can make efficient determination and correction. Note that a method for informing of likelihood is not limited to the method described above, and another method may be applied as long as the operator can determine the likelihood.

The disclosure is not limited to the embodiment described above, and various modifications, changes, and improvements are possible without departing from the spirit of the disclosure. For instance, the exemplary embodiments described above may be configurated in combination as appropriate.

In the exemplary embodiment, as an example, a mode has been described, in which each processing is implemented by software. A process equivalent to the flowchart of the processing may be implemented, for instance, in an application specific integrated circuit (ASIC), and the processing may be processed by hardware. In this case, as compared with when each processing is implemented by software, speeding up of processing is achieved.

In the above-described exemplary embodiment, a mode has been described, in which the business card management program is installed in a ROM. However, the disclosure is not limited to this. The business card management program according to the disclosure may be provided in a format with recorded on a computer-readable recording medium. For instance, the business card management program according to the disclosure may be provided in a format with recorded on an optical disk, such as a compact disc (CD)-ROM or a digital versatile disc (DVD)-ROM. In addition, the business card management program according to the disclosure may be provided in a format with recorded on a semiconductor memory, such as a universal serial bus (USB) memory and a flash memory. Furthermore, the business card management device may obtain a program through a communication line from an external device connected to the communication line.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A business card management device comprising:
a processor configured to:
associate, upon a determination that first business card data obtained by performing character recognition on an image of a business card matches second business card data pre-stored, the second business card data pre-stored in association with the image of the business card; and
receive, upon a determination that the first business card data does not match any business card data pre-stored, an input of information to the first business card data.

2. The business card management device according to claim 1,
wherein the processor is configured to:
upon a determination that the first business card data obtained by performing character recognition on the image of the business card does not match any second business card data pre-stored and content of the first business card data is correct, store the first business card data in association with the image of the business card; and
upon a determination that the first business card data obtained by performing character recognition on the image of the business card does not match any second business card data pre-stored and content of the first business card data is incorrect, receive an input of information to the first business card data, and store the information in the received input in association with the image of the business card.

3. The business card management device according to claim 2,
wherein the processor is configured to:
in correct or incorrect determination processing for the content of the first business card data, determine correctness or incorrectness based on whether likelihood of characters included in the first business card data meets a predetermined criterion.

4. The business card management device according to claim 1,
wherein an attribute is assigned to each of corresponding characters or character strings included in the first business card data and the second business card data, and
the determination that the first business card data matches the second business card data is made when a character or a character string assigned a predetermined attribute meets a predetermined condition, the predetermined attribute being common between the first business card data and the second business card data.

5. The business card management device according to claim 2,
wherein an attribute is assigned to each of corresponding characters or character strings included in the first business card data and the second business card data, and
the determination that the first business card data matches the second business card data is made when a character or a character string assigned a predetermined attribute meets a predetermined condition, the predetermined attribute being common between the first business card data and the second business card data.

6. The business card management device according to claim 3,
wherein an attribute is assigned to each of corresponding characters or character strings included in the first business card data and the second business card data, and
the determination that the first business card data matches the second business card data is made when a character or a character string assigned a predetermined attribute meets a predetermined condition, the predetermined attribute being common between the first business card data and the second business card data.

7. The business card management device according to claim 4,
wherein a plurality of predetermined conditions, each of which is the predetermined condition, are defined for a plurality of attributes, respectively, and
the determination that the first business card data matches the second business card data is made when the plurality of predetermined conditions are all met.

8. The business card management device according to claim 5,
wherein a plurality of predetermined conditions, each of which is the predetermined condition, are defined for a plurality of attributes, respectively, and
the determination that the first business card data matches the second business card data is made when the plurality of predetermined conditions are all met.

9. The business card management device according to claim 6,
wherein a plurality of predetermined conditions, each of which is the predetermined condition, are defined for a plurality of attributes, respectively, and
the determination that the first business card data matches the second business card data is made when the plurality of predetermined conditions are all met.

10. A non-transitory computer readable medium storing a business card management program causing a computer to execute a process comprising:
associating, upon a determination that first business card data obtained by performing character recognition on an image of a business card matches second business card data pre-stored, the second business card data pre-stored with the image of the business card; and
receiving, upon a determination that the first business card data does not match any business card data pre-stored, an input of information to the first business card data.

11. A business card management device comprising:
means for associating, upon a determination that first business card data obtained by performing character recognition on an image of a business card matches second business card data pre-stored, the second business card data pre-stored with the image of the business card; and
means for receiving, upon a determination that the first business card data does not match any business card data pre-stored, an input of information to the first business card data.
